(19) United States
(12) Patent Application Publication
(10) Pub. No.: US 2024/0163786 A1
(43) Pub. Date: May 16, 2024

(54) MULTIMODAL WIRELESS AND DETERMINISTIC MODE OPERATION

(71) Applicant: Cisco Technology, Inc., San Jose, CA (US)

(72) Inventors: Pascal Thubert, Roquefort-les-Pins (FR); J. P. Vasseur, Issy Les Moulineaux (FR); Patrick Wetterwald, Mouans Sartoux (FR); Eric Levy-Abegnoli, Valbonne (FR); Jerome Henry, Pittsboro, NC (US)

(73) Assignee: Cisco Technology, Inc., San Jose, CA (US)

(21) Appl. No.: 18/455,871

(22) Filed: Aug. 25, 2023

Related U.S. Application Data
(60) Provisional application No. 63/383,108, filed on Nov. 10, 2022.

(51) Int. Cl. H04W 48/20; H04W 48/08

(52) U.S. Cl. CPC H04W 48/20; H04W 48/08; H04W 84/12

(57) ABSTRACT

Multimodal wireless and deterministic mode operation may be provided. An indication may be provided to a client device by an Access Point (AP) that the AP supports multimode operation and which current sub-mode is enabled. Then a determination may be received from the client device to perform an operation based on the indication that the AP supports multimode operation and which sub-mode is currently enabled wherein the operation comprises one of prefer the AP and avoid the AP.

### RELATED APPLICATION

Under provisions of 35 U.S.C. § 119(e), Applicant claims the benefit of U.S. Provisional Application No. 63/383,108, filed Nov. 10, 2022, which is incorporated herein by reference.

### TECHNICAL FIELD

The present disclosure relates generally to providing multimodal wireless and deterministic mode operation.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing multimodal wireless and deterministic mode operation;

FIG. 2 is a flow chart of a method for providing multimodal wireless and deterministic mode operation;

FIG. 3 illustrates orchestration of a plurality of Access Points (APs); and

FIG. 4 is a block diagram of a computing device.

### DETAILED DESCRIPTION

### Overview

Multimodal wireless and deterministic mode operation may be provided. An indication may be provided to a client device by an Access Point (AP) that the AP supports multimode operation and which current sub-mode is enabled. Then a determination may be received from the client device to perform an operation based on the indication that the AP supports multimode operation and which sub-mode is currently enabled wherein the operation comprises one of prefer the AP and avoid the AP.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Third Generation Partnership Project (3GPP) has served deterministic and other specific traffic. For example, they have put in place a mechanism that separates the new calls in a random-access portion of the spectrum (e.g., the Random Access Control Channel (RACH)), and a deterministic allocation of spectrum in the time and frequency domains for joined nodes of so-called Resource Blocks (RBs).

With Fifth-Generation (5G), the 3GPP designers realized that a single common approach for all access types may not be enough and selective tunings of the Media Access Control (MAC) and Physical (PHY) modes of operations were required to accommodate vastly different categories of traffic. To satisfy the requirements of emerging applications such as intelligent transportation, augmented/virtual reality, industrial automation, etc., 3GPP defined three main service categories in 5G New Radio: i) enhanced Mobile Broadband (eMBB); ii) massive Machine-Type Communication (mMTC); and iii) Ultra-Reliable Low-Latency Communication (URLLC).

As an example, mMTC may expect massive amounts of devices that speak rarely, and for which assigning resource blocks makes little sense. MMTC devices may pass the data in the same frame as the call, over the RACH channel. To serve such applications, the RACH portion of the spectrum may be wider than in the case of an eMBB network that is tuned for throughput.

Wi-Fi may have focused on throughput only, starving Internet-of-Things (IoT) and deterministic applications. Faced with the aggressive marketing and the technology of the 3GPP approach for industrial and automation applications, Wi-Fi is bound to provide similar modes of operation that profile the AP behavior when facing different loads.

Several consequences may arise. For example, a new mode may be defined that is optimized for deterministic clients and may only serve classical client devices as collateral. Embodiments of the disclosure may consider the needed properties and may protect several propositions that may enable Wi-Fi 8 to serve the deterministic flows within their fundamental constraints of reliability and guaranteed latency. An example property may be the capability to handle fast periodic control loops, with limited room for retries in the periodic schedule, which may comprise a classic requirement in industrial automation. This may imply that any point of time may be needed for a deterministic packet and there may not be an unbound period every 100 ms for broadcasts for example.

While some APs serve this new deterministic mode, other APs may be needed to serve other modes of operation and embodiments of the disclosure may not require all APs to support the use of the deterministic mode. A next problem may be for an AP to select autonomously its mode of operation, and for a collection of APs in a building or a factory, how to distribute their roles so all client devices (i.e., Stations (STAs)) may be optimally served for their needs.

Embodiments of the disclosure may provide for different Wi-Fi modes of operation and provide an operation for a mode dedicated to deterministic wireless. It may also provide the signaling between the AP and the client device. The deterministic mode may have the following characteristics: i) Transmit opportunity (TXOP) smaller than a short period TO; ii) auto-preemption of the current frame by the sender when it retains the channel for TO during a frame; iii) no broadcast (but the beacon); and iv) low latency and high reliability variations. Embodiments of the disclosure may require a change in the Wi-Fi air transmissions because the mode may be indicated and the over-the-air behavior changes.

Embodiments of the disclosure may also distribute the channels and APs to optimally cover the needs of the client devices that are either expressed by the client devices or discovered dynamically by the AP. An optimization function may ensure that the most important flows (e.g., deterministic) may be fully served and that other flows may be optimally served as well, based on the current and predicted needs of the client devices.

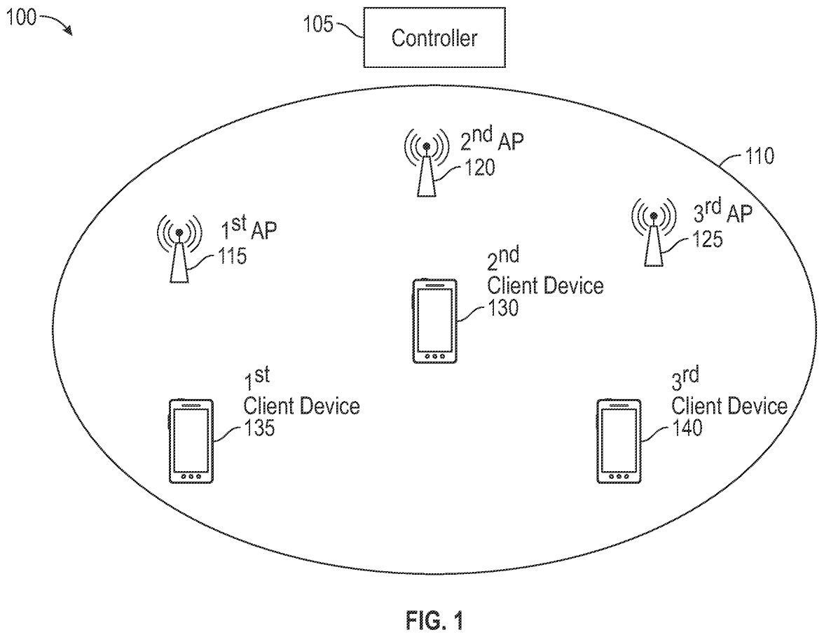

FIG. 1 shows an operating environment 100 for providing multimodal wireless and deterministic mode operation. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. The plurality of APs may provide wireless network access to a plurality of client devices as they move within coverage environment 110. The plurality of client devices may comprise, but are not limited to, a first client device 130, a second client device 135, and a third client device 140. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard for example.

The plurality of APs and the plurality of client devices may use Multi Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide multimodal wireless and deterministic mode operation.

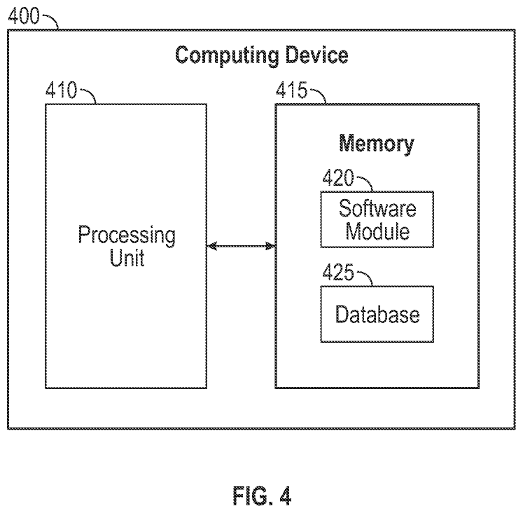

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 4, the elements of operating environment 100 may be practiced in a computing device 400.

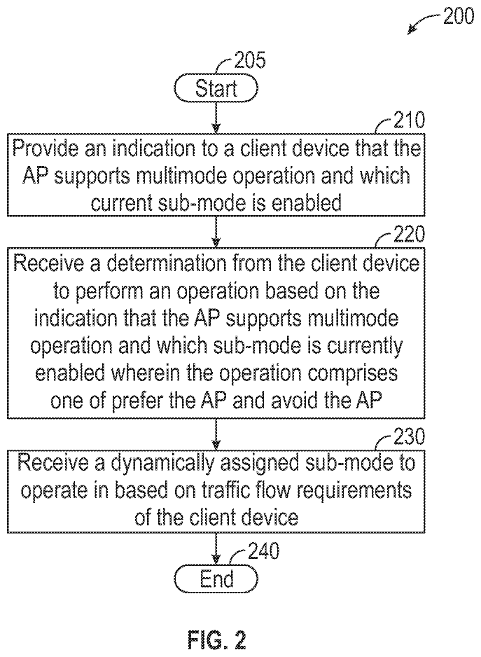

FIG. 2 is a flow chart setting forth the general stages involved in a method 200 consistent with embodiments of the disclosure for providing multimodal wireless and deterministic mode operation. Method 200 may be implemented using a computing device 400 as described in more detail below with respect to FIG. 4. Computing device 400 may be implemented using one or more of the plurality of APs such as first AP 115, second AP 120, or third AP 125 for example. Ways to implement the stages of method 200 will be described in greater detail below.

Method 200 may begin at starting block 205 and proceed to stage 210 where first AP 115 may provide an indication to a client device (e.g., first client device 130) that the AP supports multimode operation and which current sub-mode is enabled. For example, embodiments of the disclosure may support deterministic client device flows at the AP. This may include signaling by the AP that it is operating in that mode (e.g., in beacons and/or probe responses where a capability bit may be set). In one embodiment, an extended capability field may include a sub-element that informs the client device about the AP support for multi-modal mode, along with the sub-mode currently enabled (e.g., multimodal supported, mMTC mode on). In another embodiment, the AP may mention multimode support, and the detail of the reactive sub-mode may be exchanged as part an exchange.

From stage 210, where first AP 115 provides the indication to the client device (e.g., first client device 130) that the AP supports multimode operation and which current sub-mode is enabled, method 200 may advance to stage 220 where first AP 115 may receive a determination from the client device (e.g., first client device 130) to perform an operation based on the indication that first AP 115 supports multimode operation and which sub-mode is currently enabled wherein the operation comprises one of prefer the AP and avoid the AP. For example, the exchange in stage 210 may inform the client device about the current AP mode, providing the client device with the ability to prefer or avoid the AP for its exchanges, based on the client device type and configuration for example. In the same way, the client device may inform its current AP of its preferred mode. The AP may keep track of this information for all the client devices that are associated with it, and it may decide to change its operating mode based on some decision criteria.

Deterministic Mode

In a deterministic mode, the client device may also not expect broadcast. If the AP determines that a broadcast should be passed to one or more of its client devices, the broadcast may be sent as a series of unicasts. Alternatively, only a subset of APs may support broadcasts.

Deterministic traffic may be reserved. The reservation may be periodic and for a duration. This may mean that there may be a regular time slot (==RU for a duration) associated to the transmission. A period TO may be defined for the network and passed in the beacon. This may be the longest TXOP and it may be shorter than the time it takes to send a frame. If that is so, the sender may interrupt its transmission using the frame preemption mechanism.

If a deterministic time slot started within that TO, the AP may take over the medium using a short Interframe Space (IFS) and may schedule the deterministic Resource Unit (RU). Else the sender, using a short IFS that does not leave room for another sender to take the medium, resumes the transmission of the frame for another TO max.

Low Latency Mode

The low latency mode may comprise a variation of the deterministic mode where there may be no gap between a deterministic packet for other classes of packets. Instead, a periodic time slot may be reserved at a period T1 for each low latency flow. A maximum number of flows may be defined based on T1, the maximum frame size at minimum Modulation and Coding Scheme (MCS), and the number of RUs. The AP may schedule the RU/time matrix at every period of T1 for example.

Another difference between the low latency mode and the deterministic mode may be that the AP does not expect a transmission in the time slot. There may or may not be a packet, but if there is, the delay for transmission may be bounded. The AP and the client device may opportunistically use their transmit timeslots for non-express traffic when there is no express traffic in queue. The expectation may be that at most one express frame shows up in a period of T1 for a given flow/time slot.

High Reliability Mode

The high reliability mode may also relate to the deterministic mode. The high reliability mode may be less constrained by latency than the low latency mode and may allow for a limited number of retries. The flow descriptor may indicate the credit of time between reception of the frame and the last acceptable time to forward. It may hint how many retries are expected, though ultimately it may be the AP that decides how and when to retry during the allowed period. After that, the packet may be destroyed.

Once first AP 115 receives the determination from the client device (e.g., first client device 130) to perform the operation based on the indication that first AP 115 supports multimode operation and which sub-mode is currently enabled wherein the operation comprises one of prefer the AP and avoid the AP in stage 220, method 200 may continue to stage 230 where first AP 115 may receive a dynamically assigned sub-mode to operate in based on traffic flow requirements of the client device (e.g., first client device 130). For example, in a conventional deployment, APs may be spaced and attributed non-overlapping channels. The trend in both Wi-Fi and 5G may be to augment the density, the number of non-overlapping channels, and the frequency of the transmissions, while the range is reduced.

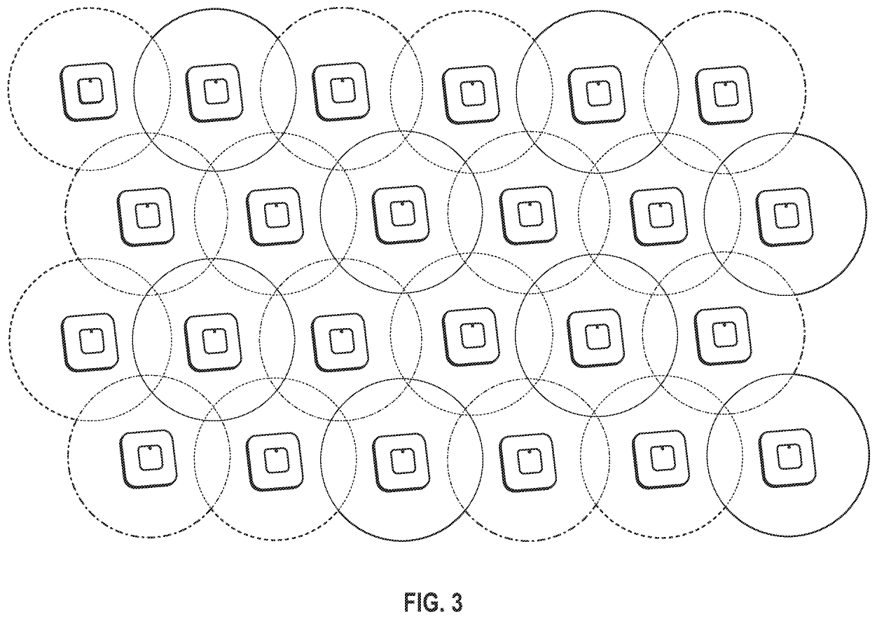

Embodiments of the disclosure may attribute the lower frequencies (e.g., longer range) to traditional modes that support broadcast mode of operation whereas higher frequencies (e.g., 6 GHz band and the 60 GHz band (i.e., mmwave)) may be assigned to deterministic traffic. As illustrated by FIG. 3, high densities of APs may increase the chances of line of sight communication with better signal and less collisions to meet the needs of time sensitive applications.

For 5G and traditional Wi-Fi, higher density may help to provide more spectrum per client device, and may increase either the number of client devices or their throughput. When multimodal Wi-Fi is provided, APs may be attributed modes, and the range of APs operating different modes may physically overlap to meet the needs of collocated client devices.

Embodiments of the disclosure may provide an orchestration of dynamically assigning AP modes on a covered area based on dynamically discovered traffic flow requirements. This orchestration problem may be divided in several stages: i) Flow Classification; ii) Channel Attribution; iii) AP coverage; and iv) AP orchestration.

Flow Classification

In a Wi-Fi 8 multimode embodiment, client devices may express their needs in the form of an ordered list of preferred modes (e.g., as indicated in active beacons). The AP may indicate the supported modes in its beacons/probe responses, and the client device may indicate its preference in the association request. The AP may confirm the current mode in the association response (and in a mode-change action frame, when the change occurs after association). When multi-band is in operation, the 11k reduced neighbor list may also mention the neighbors' mode, thus allowing the client device to privilege in its scans the channels where APs supporting its preferred mode are operating. When that is not available (e.g., legacy), the flows may be observed based on frame size and intervals. Deterministic flows may typically be periodic, with high Quality-of-Service (QoS), and in the case of automation, smaller frames.

In an embodiment of the disclosure, the system may rely on a series of rules configured by Subject Matter Expert (SME) so as to classify the deterministic versus non-deterministic flows. In another embodiment, a Machine Learning approach may be used to determine whether a traffic is deterministic or not. A known property of such traffic may relate to the seasonal nature of the traffic. To that end, a network protocol system may be used on each AP receiving traffic from a client device (with potential down sampling) and various techniques may be used to detect seasonal traffic that may also be deterministic.

Channel Attribution

Channel ranges (e.g., 2.4 Ghz, 5 GHz, 6 GHz, or subranges thereof) may be assigned per mode. Opportunistically, a channel in a range that is attributed to mode A may be assigned to mode B, but the expectation may be that in most cases the modes may operate in different ranges so the problems of managing the stations inside a range may be handled separately.

AP Coverage

AP Dominating Sets (AP-DS) may be composed for each frequency range that ensure coverage of the area where the client devices are located. A dominating set may be such that each client device is in range of at least one AP. The range of each AP may be determined in advance, and the possible dominating sets at each point of time may be those that cover all the client devices that indicate their preference for that mode. Dominating sets may be orthogonal when they do not share a single AP.

AP Orchestration

Orthogonal AP-DS may be chosen to best cover the client devices considering their mode preference, location, bandwidth needs, and predicted variations thereof. Once first AP 115 receives the dynamically assigned sub-mode to operate in based on traffic flow requirements of the client device (e.g., first client device 130) in stage 230, method 200 may then end at stage 240.

FIG. 4 shows computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for providing multimodal wireless and deterministic mode operation as described above with respect to FIG. 2. Computing device 400, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
providing an indication to a client device by an Access Point (AP) that the AP supports multimode operation and which current sub-mode is enabled; and
receiving a determination from the client device to perform an operation based on the indication that the AP supports multimode operation and which sub-mode is currently enabled wherein the operation comprises one of prefer the AP and avoid the AP.

2. The method of claim 1, wherein the current sub-mode comprises a deterministic mode.

3. The method of claim 2, wherein traffic in the deterministic mode is reserved.

4. The method of claim 1, wherein the current sub-mode comprises a low latency mode.

5. The method of claim 4, wherein, with traffic in the low latency mode, no gap exists between deterministic packets and packets of other classes.

6. The method of claim 1, wherein the currently enabled sub-mode comprises a high reliability mode.

7. The method of claim 1, further comprising receiving, by the AP, a dynamically assigned sub-mode to operate in based on traffic flow requirements of the client device.

8. A system comprising:
a memory storage; and
a processing unit disposed in an Access Point (AP) and coupled to the memory storage, wherein the processing unit is operative to:
provide an indication to a client device that the AP supports multimode operation and which current sub-mode is enabled; and
receive a determination from the client device to perform an operation based on the indication that the AP supports multimode operation and which sub-mode is currently enabled wherein the operation comprises one of prefer the AP and avoid the AP.

9. The system of claim 8, wherein the current sub-mode comprises a deterministic mode.

10. The system of claim 9, wherein traffic in the deterministic mode is reserved.

11. The system of claim 8, wherein the current sub-mode comprises a low latency mode.

12. The system of claim 11, wherein, with traffic in the low latency mode, no gap exists between deterministic packets and packets of other classes.

13. The system of claim 8, wherein the currently enabled sub-mode comprises a high reliability mode.

14. The system of claim 8, further comprising the processing unit being operative to receive a dynamically assigned sub-mode to operate in based on traffic flow requirements of the client device.

15. A non-transitory computer-readable medium that stores a set of instructions which when executed perform a method executed by the set of instructions comprising:
providing an indication to a client device by an Access Point (AP) that the AP supports multimode operation and which current sub-mode is enabled; and
receiving a determination from the client device to perform an operation based on the indication that the AP supports multimode operation and which sub-mode is currently enabled wherein the operation comprises one of prefer the AP and avoid the AP.

16. The non-transitory computer-readable medium of claim 15, wherein the current sub-mode comprises a deterministic mode.

17. The non-transitory computer-readable medium of claim 16, wherein traffic in the deterministic mode is reserved.

18. The non-transitory computer-readable medium of claim 15, wherein the current sub-mode comprises a low latency mode.

19. The non-transitory computer-readable medium of claim 18, wherein, with traffic in the low latency mode, no gap exists between deterministic packets and packets of other classes.

20. The non-transitory computer-readable medium of claim 15, wherein the currently enabled sub-mode comprises a high reliability mode.
